(19) United States
(12) Patent Application Publication
(10) Pub. No.: US 2019/0392965 A1
(43) Pub. Date: Dec. 26, 2019

(54) HIGH-VOLTAGE INSULATOR HAVING AN ARC PROTECTION RING

(71) Applicant: Bayernwerk AG, Regensburg (DE)

(72) Inventor: Wolfgang Tauber, Eschenbach (DE)

(21) Appl. No.: 16/466,592

(22) PCT Filed: Dec. 6, 2017
(86) PCT No.: PCT/EP2017/081606

§ 371 Date: Jun. 4, 2019

(30) Foreign Application Priority Data
Dec. 6, 2016 (EP) 16202324.6

(51) Int. Cl. H01B 17/44; H01B 17/02; H01B 17/56

(52) U.S. Cl. CPC H01B 17/44; H01B 17/56; H01B 17/02

(57) ABSTRACT

The invention relates to a high-voltage insulator (1) comprising a long rod-type insulator (10) having a shaft (11) and circular shields (12) which are arranged thereon, comprising an insulator cap (2) at the top end of the long rod-type insulator (10) for fastening the high-voltage insulator (1) to a high-voltage mast, and comprising an arc protection ring (3) which surrounds the insulator cap (2) or that portion of the long rod-type insulator (10) which is situated closest to the insulator cap (2), wherein at least the topmost shield (12) of the long rod-type insulator (10), which shield is situated closest to the insulator cap (2), is designed as a protective shield (12′) for the other shields (12″), wherein the maximum diameter of the other shields (12″) is at least 30 mm smaller than the inside diameter of the arc protection ring (3), the diameter of the at least one protective shield (12′) is at least 10 mm smaller than the inside diameter of the arc protection ring (3), and the diameter of the at least one protective shield (12′) is at least 20 mm larger than the maximum diameter of the other shields (12″).

The invention relates to a high-voltage insulator with an arc protection ring.

High-voltage overhead lines are often carried by high-voltage masts. In order to isolate the high-voltage masts electrically from the high-voltage lines, high-voltage insulators are provided at each of the suspension points between the high-voltage lines and the high-voltage masts. Long rod-type insulators, which are suspended from cross-members of the high-voltage mast, and to whose free ends the high-voltage line is fastened, are often used for this.

In occasional cases—for example as a result of a lightning strike or because of heavily soiled insulators—a voltage flashover, manifesting as an arc reaching over the actual insulator, can occur across the high-voltage insulator. So-called arc protection rings are known in order to avoid damage to the insulator caused by the hot arc plasma that occurs here. The arc protection rings are arranged here at both ends of the insulator itself, and surround the insulator in an essentially annular manner. Since the arc protection rings are made of metal and thus are electrically conductive, either the arc develops immediately between the arc protection rings, or the foot points of the arc migrate to the arc protection rings shortly after the arc has initiated. A direct contact or an immediate closeness between the arc and the insulator itself consequently only exists for a short time, or is entirely avoided. Damage to the insulator can thereby be reduced.

Even if the high-voltage insulators are designed adequately for the desired insulation between the high-voltage line and the high-voltage mast, the ground faults and ground short-circuits just mentioned, in which a high-voltage insulator is by-passed and the high-voltage line attached to it is connected via the high-voltage mast to the ground potential, occur repeatedly. Depending on how the neutral point of the high-voltage network is handled and on the duration of the network fault, these single-pole faults can have massive effects on downstream networks and connected consumers, as a result of which efforts are made in the prior art to reduce these malfunctions and to increase operational security.

Since one cause for the occurrence of ground faults and ground short-circuits has been identified as the occurrence of an arc on the high-voltage insulators due to bird droppings, either immediately impinging or accumulated—in particular in combination with moisture—the technical specification of the International Electrotechnical Commission IEC/TS 60815-1:200—“Selection and dimensioning of high-voltage insulators intended for use in polluted conditions—Part 1:
Definitions, information and general principles” proposes fitting “dissuasive devices or alternate perches, appropriate to the local fauna and structure design” to avoid birds settling on the high-voltage masts above the high-voltage insulators, doing their business and thus soiling the high-voltage insulators. It has, however, been found that corresponding equipment can only reduce ground faults and ground short-circuits to a modest extent.

Protective devices in which canopies are provided directly at the high-voltage mast above the high-voltage insulators on the mast cross-members that are designed to keep bird droppings off the high-voltage insulators are also known. Even though the soiling of the high-voltage insulators can be significantly reduced through suitable canopies, the canopies according to the prior art have certain disadvantages. The costs for the procurement and assembly of the canopies are considerable, the static strength of the mast is negatively affected, particularly in the presence of ice, snow and strong wind, and servicing work on the cross-members of the mast and the high-voltage insulators is made more difficult.

The invention is therefore based on the object of providing a high-voltage insulator with an arc protection ring in which the disadvantages known in the prior art no longer occur or only do so to a reduced extent.

This object is achieved by a high-voltage insulator according to the principal claim. Advantageous developments are the objects of the dependent claims.

The invention accordingly relates to a high-voltage insulator comprising a long rod-type insulator with a shaft and circular shields arranged thereon, an insulator cap at the upper end of the long rod-type insulator for fastening the high-voltage insulator to a high-voltage mast, and an arc protection ring which surrounds the insulator cap or that portion of the long rod-type insulator which is situated closest to the insulator cap, wherein at least the topmost shield of the long rod-type insulator that is situated closest to the insulator cap is designed as a protective shield for the other shields, wherein the maximum diameter of the other shields is at least 30 mm smaller than the inside diameter of the arc protection ring, the diameter of the at least one protective shield is at least 10 mm smaller than the inside diameter of the arc protection ring, and the diameter of the at least one protective shield is at least 20 mm larger than the maximum diameter of the other shields.

According to the invention it is thus provided that at least one of the circular shields provided at the long rod-type insulator—namely at least the shield that is closest to the insulator cap and thereby the topmost shield—is designed as a protective shield for the other shields, wherein the functionality of the insulator or of the arc protection ring should not be restricted. “Other shields” refers here to those shields of a long rod-type insulator that are not designed as protective shields or corresponding to a protective shield.

The at least one shield of the long rod-type insulator that is designed as a protective shield should here have a radius at least 20 mm greater than the other shields, wherein, in particular when the diameters of the other shields alternate, this should be based on the largest diameter of the other shields. It has been found that an adequate protection against soiling of the other lower-lying shields with bird droppings can already be achieved through a protective shield whose diameter is greater by a sufficient amount.

The bird droppings that have landed on a protective shield can be washed off by rain which, due to the greater diameter, falls in particular on the shields that are designed as protective shields, so that a self-cleaning effect occurs. This applies in particular to the topmost shield, designed as a protective shield, of the long rod-type insulator. As a result of the diameter of the shields being at least 20 mm larger, it is ensured that the bird droppings released from the shields designed as protective shields do not land on the other shields lying beneath.

In that it is furthermore provided according to the invention that the diameter of the at least one shield designed as a protective shield is at least 10 mm smaller than the internal diameter of the arc protection ring, it is ensured that neither is the arc protection impaired nor are the shields that are designed as protective shields damaged when an arc occurs. If, in particular, only the topmost shield of the insulator is designed as a protective shield, a spacing of 10 mm between the shield and the protective ring can be sufficient, since, due to the geometry resulting in the axial direction of the long rod-type insulator from the immediate proximity between the shield and the protective ring, when an arc with a foot point at the arc protection ring occurs, this shield is at a sufficient distance from the arc, and no damage is to be expected. The other shields, since they have a diameter that is at least 30 mm smaller than the inner diameter of the arc protection ring, are also sufficiently protected from damage caused by an arc.

It is preferred for the diameter of the at least one protective shield to be at least 17.5 mm and/or at most 42.5 mm smaller than the inner diameter of the arc protection ring. Through the said lower limit it is here ensured that, in addition to the topmost shield, also other shields designed as protective shields are sufficiently protected from damage caused by an arc that might occur. Through the maximum difference in diameters of 42.5 mm, it is ensured that the one foot point of an arc that might arise at the long rod-type insulator moves immediately to the arc protection ring.

Preferably the diameter of the at least one protective shield is at most 40 mm larger than the maximum diameter of the other shields. A diameter of the protective shields that is at most 40 mm larger is sufficient to protect the other shields from the accumulation of bird droppings and to prevent a conductive wetting of the other shields with a mixture of water and bird droppings when it rains. At the same time it is usually possible to ensure through an appropriate limitation of the difference in diameters that the fittings for fastening both the high-voltage insulator and the arc protection ring can remain unchanged from an insulator according to the prior art with comparable insulation properties.

It is preferable for the lowest shield, at the greatest distance from the insulating cap, to be designed corresponding to a protective shield. Even if this lowest shield cannot provide any protective effect to the other shields against bird droppings, a design corresponding to that of a protective shield—that is, in particular, with a comparable diameter—is advantageous for the transport and storage of the high-voltage insulator or of its long rod-type insulator.

It is further preferable for the at least one shield that is not located at an end of the long rod-type insulator to be designed as a protective shield. In that an inner shield of the long rod-type insulator is implemented as a protective shield—that is having a diameter that is comparable to or the same as that of the other protective shields—the risk of the long rod-type insulator breaking during transport and storage in a horizontal position can be further reduced. In particular in the case of long insulators, an inner protective shield can also protect the shields lying underneath from soiling that has not already been kept away by the topmost protective shield.

At least two neighboring other shields of the long rod-type insulator can have different overhangs. The alternation of shield diameters is therefore no longer limited to pairs of protective shields and other shields, but explicitly comprises at least two adjacent other shields. The leakage path over the insulator can be extended by respective adjacent shields having different overhangs.

The long rod-type insulator can comprise at least 10, preferably at least 15 shields and/or be made of ceramic or glass-fiber reinforced plastic. The long rod-type insulator can, in particular, be designed according to the DIN EN 61466/2 (composite long rod-type insulators) or DIN 48006/2 (long rod-type insulators) standards, wherein the shields designed as protective shields represent modifications of these standards. The individual shields of the long rod-type insulator can have surrounding drip edges at their outer edge. The high-voltage insulator can also comprise an arc protection ring at its lower end.

The invention will now be described by way of example on the basis of advantageous forms of embodiment with reference to the appended drawings. Here:

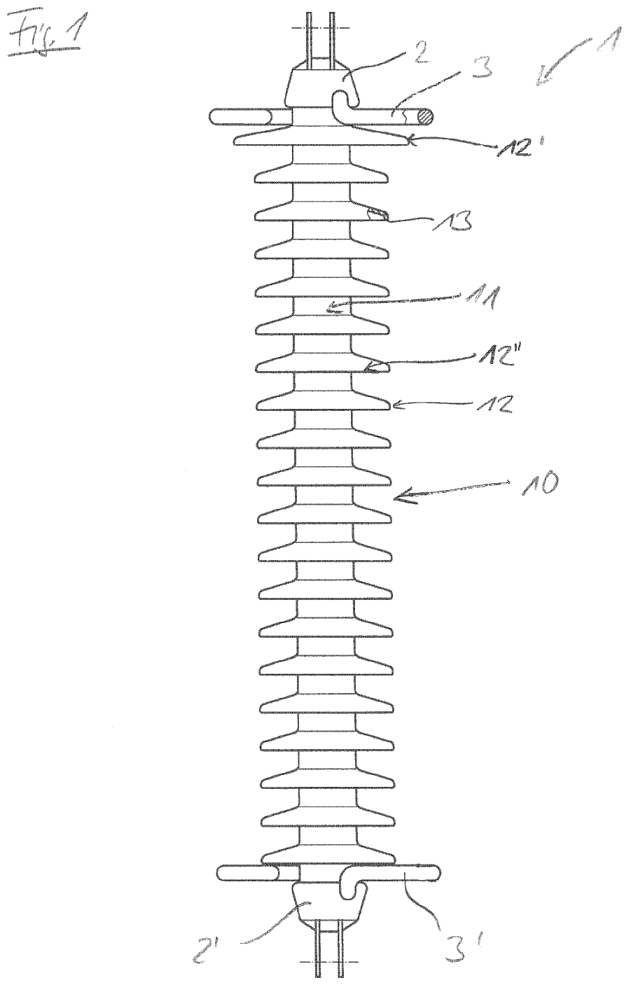

FIG. 1: shows a first exemplary embodiment of a high-voltage insulator according to the invention with an arc protection ring; and

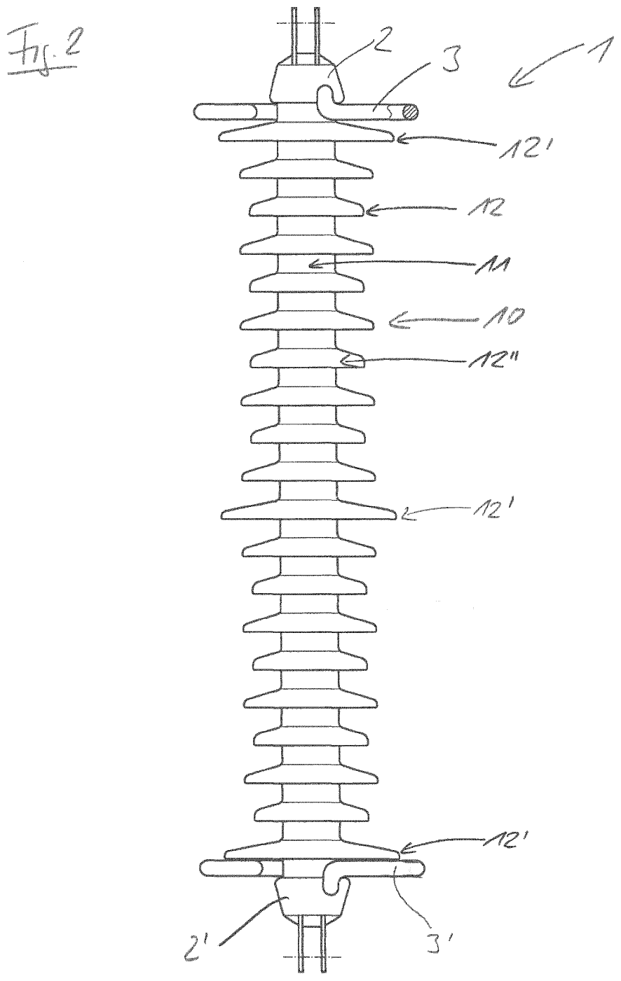

FIG. 2: shows a second exemplary embodiment of a high-voltage insulator according to the invention with an arc protection ring.

A first exemplary embodiment of a high-voltage insulator 1 according to the invention is shown in FIG. 1.

The high-voltage insulator 1 comprises a long rod-type insulator 10 that is connected at its topmost end with an insulating cap 2. The high-voltage insulator 1, or a cross-member of a high-voltage mast, can be fastened through this insulator cap 2, which is designed as a fork cap. An insulator cap 2′, also designed as a fork cap, is also provided at the bottom end of the long rod-type insulator 10. The high-voltage line can be fastened to this lower insulator cap 2′.

Arc protection rings 3, 3′ are arranged around each of the insulator caps 2, 2′, and surround the respective ends of the long rod-type insulator 10. The arc protection rings 3, 3′ are formed here as metal rings which, in the event of arc over the high-voltage insulator, can form foot points through which the arc current is dissipated to ground. The two arc protection rings 3, 3′ can here comprise arcing horns in order to be self-extinguishing.

The long rod-type insulator 10 is made of ceramic, and comprises a shaft 11 with circular shields 12 arranged thereon. Twenty shields 12 are provided in the exemplary embodiment illustrated. The long rod-type insulator 10, and thereby also the shields 12, are largely implemented according to the DIN 48006/2 standard, wherein all of the shields 12 comprise drip edges 13 surrounding their outer edge. As a result, both the insulator caps 2, 2′ and the arc protection rings 3, 3′, can also be standardized components.

Varying from the said standard, however, the topmost shield 12 of the long rod-type insulator 10, i.e. the topmost insulator cap 2, is designed as a protective shield 12′. Whereas the other shields 12″ that are not designed as protective shields have a maximum diameter that is around 37.5 mm smaller than the inner diameter of the arc protection rings 3, 3′, the diameter of the protective shield 12′ is only about 17.5 mm smaller than the inner diameter of the topmost arc protection ring 3. The diameter of the protective shield 12′ is thus around 20 mm larger than the maximum diameter of the other shields 12″.

As a result of the design of the topmost shield 12 of the long rod-type insulator 10 as a protective shield 12′, the other shields 12″ lying underneath are protected from bird droppings. At the same time, the functionality of the arc protection rings 3, 3′ is not restricted in any way.

A second exemplary embodiment of a high-voltage insulator 1 according to the invention is illustrated in FIG. 2. Many parts of the high-voltage insulator 1 are the same as those of FIG. 1, for which reason reference is made to the above explanations. As explained below, only the long rod-type insulator 10 is implemented differently from the exemplary embodiment according to FIG. 1.

The long rod-type insulator 10 is again made of ceramic, and comprises a shaft 11 and circular shields 12 arranged thereon, wherein, however, all respective adjacent shields 12 have different overhangs or diameters. The shields 12 are each implemented analogously to the DIN 48006/2 standard, and each comprise—even though not illustrated explicitly in FIG. 2—a drip edge 13 (cf. FIG. 1).

The topmost shield 12 lying closest to the topmost insulator cap 2 of the long rod-type insulator 10, and a shield 12 located centrally and thus not at the end of the long rod-type insulator 10, are each designed as a protective shield 12′, and the lowest shield located most closely to the lowest insulator cap 2′ is designed corresponding to a protective shield 12′. The shields 12′ in question have a diameter that is about 17.5 mm smaller than the inner diameter of the two arc protection rings 3, 3′. The diameter of these shields 12 is at the same time about 20 mm larger than the maximum diameter of those shields 12″ that are not designed as protective shields 12′ or corresponding to a protective shield 12′. The diameter of the other shields 12″ that are not designed as protective shields 12′ is thus about 37.5 mm smaller than the inner diameter of the arc protection rings 3, 3′, while the smaller of the other shields in the exemplary embodiment illustrated are around 47.5 mm smaller than the said inner diameter.

The protective shields 12′ at the upper end and in the middle of the long rod-type insulator 10 offer a protection against soiling to the respective shields 12″ lying underneath, in particular from bird droppings. The lowest shield 12 of the long rod-type insulator 10 that is designed corresponding to a protective shield 12′, together with the other protective shields 12′, essentially makes the transport and storage of the long rod-type insulator 10 in a horizontal orientation easier, including in particular before the insulator caps 2, 2′ are attached to the long rod-type insulator 10.

1. A high-voltage insulator (1) comprising a long rod-type insulator (10) with a shaft (10) and circular shields (12) arranged thereon, an insulator cap (2) at the upper end of the long rod-type insulator (10) for fastening the high-voltage insulator (1) to a high-voltage mast, and an arc protection ring (3) which surrounds the insulator cap (2) or that portion of the long rod-type insulator (10) which is situated closest to the insulator cap (2),
characterized in that at least the topmost shield (12) of the long rod-type insulator (10) that is situated closest to the insulator cap (2) is designed as a protective shield (12′) for the other shields (12″), wherein the maximum diameter of the other shields (12″) is at least 30 mm smaller than the inside diameter of the arc protection ring (3), the diameter of the at least one protective shield (12′) is at least 10 mm smaller than the inside diameter of the arc protection ring (3), and the diameter of the at least one protective shield (12′) is at least 20 mm larger than the maximum diameter of the other shields (12″).

2. The high-voltage insulator as claimed in claim 1,
characterized in that the diameter of the at least one protective shield (12′) is at least 17.5 mm and/or at most 42.5 mm smaller than the inner diameter of the arc protection ring (3).

3. The high voltage insulator as claimed in one of the preceding claims,
characterized in that the diameter of the at least one protective shield (12′) is at most 40 mm larger than the maximum diameter of the other shields (12″).

4. The high-voltage insulator as claimed in one of the preceding claims,
characterized in that the lowest shield (12), at the greatest distance from the insulating cap (2) at the topmost end of the long rod-type insulator (10), is designed corresponding to a protective shield (12′).

5. The high-voltage insulator as claimed in one of the preceding claims,
characterized in that at least one shield (12) that is not at one end of the long rod-type insulator (10) is designed as a protective shield (12′).

6. The high-voltage insulator as claimed in one of the preceding claims,
characterized in that at least two neighboring other shields (12) of the long rod-type insulator (10) have different overhangs.

7. The high-voltage insulator as claimed in one of the preceding claims,
characterized in that the long rod-type insulator (10) comprises ten, preferably at least fifteen shields.

8. The high-voltage insulator as claimed in one of the preceding claims,
characterized in that the long rod-type insulator (10) is made of ceramic or glass-fiber reinforced plastic.
